(19) United States
(12) Patent Application Publication
(10) Pub. No.: US 2007/0101400 A1
(43) Pub. Date: May 3, 2007

(54) Method of providing secure access to computer resources

(75) Inventors: James Leo Freeman, London (CA); Robert Jan Nijkamp, London (CA); Scott Orlo Woolcox, London (CA)

Correspondence Address: BRUNET & CO. LTD., 10712 MELROSE DR., KOMOKA, ON, N0L-1R0, CA

(73) Assignee: OVERCOW Corporation

(21) Appl. No.: 11/261,601

(22) Filed: Oct. 31, 2005

(51) Int. Cl. H04L 9/32

(52) U.S. Cl. 726/2

(57) ABSTRACT

A method of providing varying levels of secure access to computer resources. A certificate is used to identify a particular data requester and the certificate is authenticated using asymmetrical encryption techniques, such as public-private key pairs. One or more trust authorities may be consulted to ascribe a trust level to the certificate, which is an indication of the veracity of the identity of the data requester. Individual system users may set differing levels of access to a number of shared system resources for a particular data requester. The authenticated and verified data requester is then provided with the pre-set level of access to the desired shared resource. The level of access to a particular shared system resource therefore depends upon the user the data is being accessed through, the authenticated identity of the data requester, and their ascribed trust level. The shared resource may comprise data and/or an application module that is accessed or executed through a secure symmetric encryption tunnel.

### FIELD OF THE INVENTION

The invention relates to providing user discriminated access to computer resources over a secure connection. More particularly, the invention relates to providing a data requester with a pre-set level of secure access to a shared computer resource based upon the preferences of a particular user of the shared resource. The level of secure access may be determined in part by a trust level ascribed to the data requester that may be provided, for example, by a third-party trust server.

### BACKGROUND OF THE INVENTION

In computer networking, it is desirable for a particular computer user to provide others with access to resources on his or her computer or computer network in a secure manner. Data requesters are normally required to pre-register on a given computer system with a login id and password. Once a user identifies him or herself by providing the login and password information, a secure connection is normally established that either provides the same level of access to all resources or permits a limited number of varying access levels depending on the users identity. These varying access levels are determined at a system administrator level and are applied equally across the computer network.

There is currently no way for individual users on the computer network to set their own permission levels for providing varying levels of access to personal data based on the identity of individuals seeking access to that data. Even data requesters who are personally known to a particular user cannot necessarily be trusted, as computer hackers have been known to hijack the certificates that are used as electronic identification and those certificates can, in any event, become outdated. In addition, there is currently no way for a system administrator or an individual user to pre-determine what level of access to provide to data requesters who are not known to them. Since there is no “rating system” for determining the level of trust to ascribe to the identity of a known or unknown data requester, by default the data requester is not provided any access to commercially sensitive or otherwise confidential data or applications.

There is therefore a need for a method of providing varying levels of secure access to shared computer resources that overcomes some or all of these disadvantages.

U.S. Pat. No. 6,851,113, issued to Hemsath on Feb. 1, 2005 discloses an enhanced secure shell (SSH) protocol having fine-grained access security policy management. This permits a system administrator to set permissions to access or use a particular system resource for each data requester or group thereof. This protocol still requires a data requester to have an account and login to the network before any secure access is granted. There is no teaching of the ascribing of a trust level to an identity seeking system access, either before configuration of the account or afterwards. The permission levels are set at the system administrator level and cannot be readily adjusted by individual network users. Accordingly, access to system resources is determined on a system-wide basis and individual users cannot set differing levels of access to shared resources for a particular data requester. There is therefore no need to determine a level of secure access based upon the user that data access is being requested through.

U.S. Pat. No. 6,820,063, issued to England, et al. on Nov. 16, 2004, discloses a digital rights management method for controlling access to downloaded content. An access predicate specifies the download rights of a particular subscriber. When the subscriber attempts to download certain digital content, such as an application, the access predicate is compared with a rights manager certificate. If the rights manager certificate satisfies the access predicate, the subscriber is allowed to download the digital content. Cryptographic techniques are used to protect the access predicate and the content. This invention limits access to specified applications to only designated users, however, the determination of those designated users is again made at a system-wide level. There is no provision for individual users associated with the downloaded applications to set the level of access provided to those seeking access to the applications. There is therefore no potential for differing levels of access for a particular user and accordingly no need to determine the greatest level of access to provide to that user. Furthermore, there is no assignment of trust levels to the identities of individuals seeking download access.

U.S. Pat. No. 5,659,616 issued to Sudia on Aug. 19, 1997 discloses a method for securely using digital signatures in a commercial cryptographic system. Attribute certificates are employed that allow organizations to provide differing levels of access to individuals based upon geography, age of signature, etc. These differing levels of access are again determined at a system-wide level. A particular user is therefore not provided with varying levels of access and there is no need to determine the greatest level of access applicable to a particular user.

None of this prior art discloses a method of providing varying levels of secure access to shared computer resources that permits varying levels of access to be determined by individual system users or that makes use of trust authorities to verify the authenticity of the identity claiming access to the resources.

### SUMMARY OF THE INVENTION

According to an aspect of the present invention, there is provided a method of providing varying levels of secure access to computer resources on a first computer or computer network having at least one user or group of users, the method comprising: establishing a secure connection between a second computer or computer network and the first computer or computer network using a common symmetric encryption key, the second computer or computer network having at least one data requester or group of data requesters; providing an identity and an authentication package of the requester or group of requesters to the first computer or computer network over the secure connection, the authentication package encrypted using a private key of the requester or group of requesters; for each user or group of users, checking the identity against a list of accounts associated with that user or group of users and determining whether at least one list of accounts contains the identity; authenticating the identity by decrypting the authentication package using a public key associated with the identity; for an authenticated identity, selecting a particular user or group of users it desires to access resources from over the secure connection; for a selected user or group of users, checking whether the authenticated identity is on its list of accounts; for a desired resource associated with the selected user or group of users, checking an access control list to determine the level of secure access to be provided to the requester or group of requesters for that resource, the level of secure access determined based upon both the selected user or group of users and the authenticated identity; and, providing the pre-determined level of secure access to the resource over the secure connection.

According to another aspect of the present invention, there is provided a method of providing varying levels of secure access to computer resources on a first computer or computer network, the method comprising: establishing a secure connection between a second computer or computer network and the first computer or computer network using a common symmetric encryption key, the second computer or computer network having at least one data requester or group of data requesters; providing an identity and an authentication package of the requester or group of requesters to the first computer or computer network over the secure connection, the authentication package encrypted using a private key of the requester or group of requesters; checking the identity against a list of accounts on the first computer or computer network and determining whether the list of accounts contains the identity; authenticating the identity by decrypting the authentication package using a public key associated with the identity; ascribing a level of trust to an authenticated identity based upon one or more trust tables; checking an access control list for the resource to determine the level of secure access to be provided to the requester or group of requesters, the level of secure access depending upon both the authenticated identity and the level of trust; and, providing the pre-determined level of secure access to the resource over the secure connection.

According to yet another aspect of the present invention, there is provided a method of providing varying levels of secure access to computer resources on a first computer or computer network having at least one user or group of users, the method comprising: establishing a secure connection between a second computer or computer network and the first computer or computer network using a common symmetric encryption key, the second computer or computer network having at least one data requester or group of data requesters; providing an identity and an authentication package of the requester or group of requesters to the first computer or computer network over the secure connection, the authentication package encrypted using a private key of the requester or group of requesters; for each user or group of users, checking the identity against a list of accounts associated with that user or group of users and determining whether at least one list of accounts contains the identity; authenticating the identity by decrypting the authentication package using a public key associated with the identity; ascribing a level of trust to an authenticated identity based upon one or more trust tables; for the authenticated identity, selecting a particular user or group of users it desires to access resources from over the secure connection; for a selected user or group of users, checking whether the authenticated identity is on its list of accounts; for a desired resource associated with the selected user or group of users, checking an access control list to determine the level of secure access to be provided to the requester or group of requesters for that resource, the level of secure access determined based upon the selected user or group of users, the authenticated identity and the level of trust; and, providing the pre-determined level of secure access to the resource over the secure connection.

The present invention advantageously provides for varying levels of secure access to shared computer resources for a variety of data requesters, as determined by individual users of the computer system, based upon the identity of the data requesters. A trust level associated with the data requester can also or alternatively be used by the individual users to determine the level of secure access to provide to the data requester. This advantageously allows for both known and unknown data requesters to have secure access to confidential system resources (for example, personal data and/or network accessible computer applications) based upon their trust level, without having to pre-register or otherwise provide personal or password information.

The invention allows a plethora of computer applications to be developed for secure access as shared computer resources. For example, a personal calendar application can be made available over a network that contains personal appointment information for an individual user of the network. That user can set varying levels of calendar access depending on the authenticated identity of individuals seeking access to the calendar. Suppose that the user is a doctor. The user's secretary may have one level of access (for example, to view and edit professional appointments), the user's wife may have another level of access (for example, to enter and edit social appointments) and the user's mother may have another level of access (for example, to view certain family related social appointments). An unknown remote data requester with a certain trust level may be able to enter a new appointment into the calendar and see the existence of appointments at specific times, but be unable to see any appointment detail. Other doctors in the same office may designate different people to view and edit their professional and social appointments, without having to provide access to those persons designated by their colleagues. This application can be accessed without pre-registration, without having to provide password information, and without allowing data requesters access to other shared network resources,.such as confidential patient data. This type of calendar application that permits varying levels of secure access to shared information is unavailable in the prior art and represents just one example of a host of applications that can make use of the unique advantages of the present invention.

A level of trust may be determined using trust tables stored internally on a computer network that reflect the opinions and experiences of designated users of the network. Alternatively, the designated users may belong to other, third-party networks. The designated users may be referred to as “trust authorities”. The trust level ascribed to an identity by a trust authority may be an indication of whether the certificate and public key being provided actually belongs to the individual who claims it does. In other words, when a certificate becomes compromised and can no longer be relied upon as positive proof of the identity of the person claiming to belong to that certificate, a low trust level can be ascribed to that identity by the trust authority. This effectively prevents fraudulent use of the compromised identity and limits access to shared resources.

The level of trust ascribed to a data requester may be determined using a variety of factors. The trust level ascribed to an identity may be compiled using information from a number of trust categories, for example the number of successful or fraudulent business transactions conducted by that identity, the number of times the network has been accessed successfully on the first attempt, the number of incidents of data misuse, the number of complaints logged by users, a “revocation” event by the owner of the identity in the event of suspected certificate compromise, a past or present employment relationship, or any of a number of other criteria. The level of trust may be provided as a percentage value and may be provided as a composite value reflecting the opinions and experiences of a plurality of users and/or in a plurality of trust categories. Alternatively, the trust level may be chosen based upon the ascribed trust level of a particular trust authority in a particular category. By preferring one trust authority's opinion over another's, a user is permitted to resolve conflicts in trust level ascribed to a particular identity.

Another method of determining the trust level to ascribe to a particular identity relies upon a chain of trusted authorities. For example, if an individual user of the network has been designated as a primary trust authority, then the trust level ascribed to a given data requester by that user may be relied upon by other users of the network. A user or group of users on a third-party network could also be designated as a primary trust authority. If the primary trust authority is unable to provide information on a particular identity in the chosen category, then other secondary trust authorities designated as reliable by the primary trust authority may be relied upon in ascribing a level of trust to the identity. In the event of conflicting information between secondary trust authorities, the trust level ascribed by the primary authority to a particular secondary authority may be used to resolve conflicts. In this manner, a chain of trusted authorities may be used to determine a trust level for a particular data requester in any particular category, particularly when information about that data requester is unavailable from the network's own trust tables.

A third-party trust server may be setup as a public forum for sharing information about an identity's trust level in a particular category. The third-party trust server can then be designated as a trust authority and relied upon to represent the opinions and experiences of a plurality of users with respect to a particular identity in one or more trust categories (for example, successful business transactions). Users from a number of disparate computer networks may post their experiences with that identity to the third-party trust server, which then functions as a publicly available information source for determining the trust level to ascribe to the identity in that category. A particular user or group of users may develop their own trust table or tables by consulting a number of third-party trust servers in a variety of categories.

The foregoing concepts apply equally to individual users on single computers, to individual users on computer networks, to groups of users on a single computer, or to groups of users on a network. The same applies for single data requesters or groups of data requesters. A group may be formed based on family units, work departments, teams, etc. and a similar set of access permissions can be provided to all members in the group. If individual members of the group are given a greater level of access than other members by a particular user, then the greatest level of access is applied for that individual group member. The establishment of a group is determined by a group administrator, who can then add or delete members to the group. This is particularly advantageous for corporations, as employees can be readily added to the corporate group and thereby granted access to certain internal corporate information or information belonging to corporate business partners.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 depicts a connection between a data requester and a user according to the present invention and illustrates the use of modules in the overall system architecture;

FIG. 2 is a schematic representation of an embodiment of the present invention;

FIG. 3 is a schematic representation of another embodiment of the present invention; and,

FIG. 4 is an illustration of a layered architecture comprising a plurality of modules.

### DESCRIPTION OF PREFERRED EMBODIMENTS

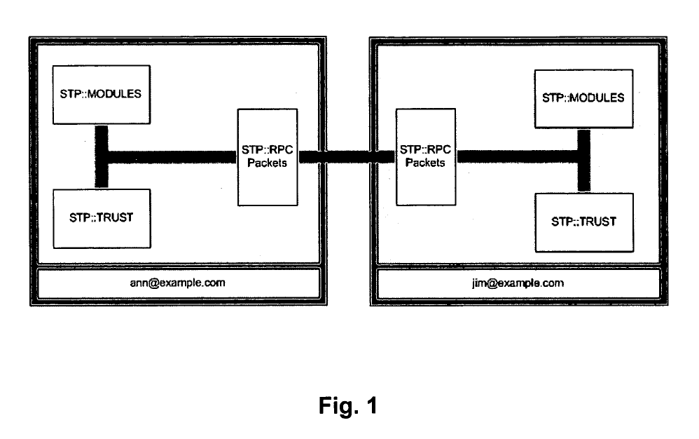

The present invention is sometimes referred to as a Secure Trust Protocol (STP). The invention provides a method for connecting disparate systems, authenticating users, controlling resources and remotely executing procedures. The invention can be employed within an enterprise to connect first and second computers on the same internal network, or between two separate first and second computer networks. With reference to FIG. 1, the method functions “peer to peer” typically with the use of trust authorities and gateways. Standard networking protocols are used for communications, however data exchange occurs with a symmetric encryption tunnel. Asymmetric encryption is used to confirm the identities of the data requester and user that data is being requested from. The protocol conducts these functions by calling modules that are provided as part of a layered architecture that will be more further described hereinafter.

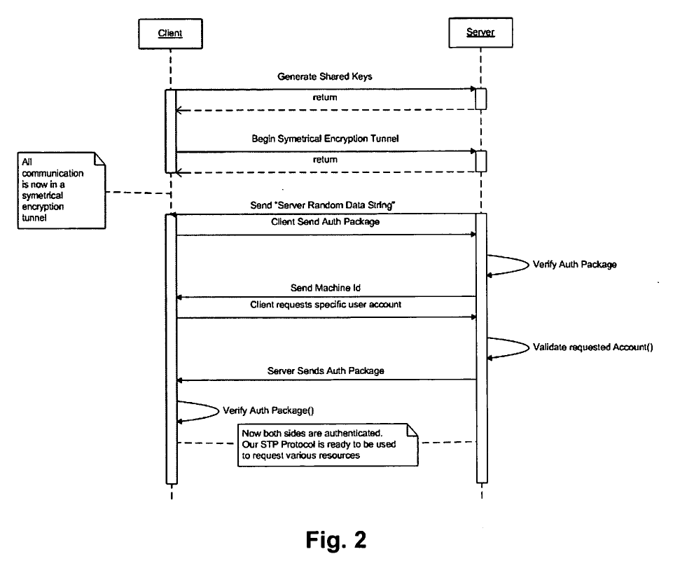

Referring to FIG. 2, a data requester or group of data requesters seeking access to data related to a particular user or group of users of a first computer or computer network does so through a secure connection. A secure connection is established between the first computer or computer network and a second computer or computer network using a common symmetric encryption key. The symmetric encryption key may be previously known to both parties or a unique symmetric encryption key may be generated for each session. One means of generating a unique common symmetric encryption key utilizes the public keys of both parties and a key exchange algorithm, such as Diffie-Hellman key exchange; however, any suitable key exchange algorithm may be used to generate the symmetric encryption key. Once a common symmetric encryption key is available to both parties, a secure connection (for example, a symmetric encryption tunnel) may be utilized for all subsequent communications between the parties in a particular session. This prevents un-authorized third-parties from “eavesdropping” on communications between the parties that could lead to a compromise in identity for either party.

Once the secure connection is established, the first computer or computer network transmits a data string to the second computer or computer network. The data string is preferably randomly generated and is used in preventing a “playback attack”, wherein a data requester simply repeats the challenge-response sequence that was once used by an authorized data requester in order to gain otherwise un-authorized access to the system.

The second computer or computer network then replies by providing an identity of the data requester or group of data requesters. In its simplest form, the identity is a text string (for example, jim@example.com), although the identity may also comprise other alpha-numeric information. The identity is normally accompanied by a hash of a certificate of the data requester or group of data requesters. The certificate comprises a public key of the data requester or group of data requesters. The hash algorithm, or one-way encryption algorithm, is used to create a numeric value relating to the certificate being hashed. A recipient of the hash can use the same algorithm on its copy of the data requester's certificate to obtain the same numeric value, thereby verifying that the sender has the same public key as the one on record and that subsequent asymmetrically encrypted communications can be opened without error. If this test fails, the data requester is disconnected before any further information is transferred.

The first computer then checks to see whether the identity is present on a list of accounts associated with the first computer. Each user of the computer typically has a list of accounts containing the identities of users that have been given permission to access computer resources accessible to that user. The first computer checks each user's list of accounts for the identity to determine whether there is a user on the computer or computer network that will provide some level of access to the data request. If there is no list of accounts containing the identity of the data requester, then the session is terminated. However, if at least one list of accounts contains the identity, then the session is allowed to continue to authentication.

When transmitting the identity, the second computer also sends an encrypted authentication package. The authentication package is asymmetrically encrypted using the private key of the data requester and can only be decrypted using the corresponding public key. The authentication package comprises a hash of the concatenation of the symmetrical encryption key with the first data string. The authentication package also includes a second data string, preferably randomly generated, provided by the second computer. After receiving the authentication package over the secure connection, the first computer uses the public key of the data requester to decrypt the authentication package, thereby verifying that the data requester's identity corresponds with its certificate. By then running the hash algorithm and obtaining the same numeric value for the concatenation, the first computer is able to verify that the data requester that encrypted the package also received the first data string and is the same entity that holds the common symmetric encryption key; this helps to ensure that there is no additional computer inserted between the first and second computers and aids in preventing a “man in the middle” attack. If the decryption of the authentication package or the verification of the hash value fails, then the data requester is disconnected with an error; otherwise, the session proceeds.

In one embodiment of the method, the data requester is then permitted to select which user or group of users it wishes to access resources from. The data requester is permitted to access resources relating to each user or group of users having the authenticated identity on its list of accounts. A list of users to select from is normally only available following authentication. The list of users to select from may contain only those users having the authenticated identity on its list of accounts. Alternatively, a list containing all users of the first computer or computer network may be accessible following authentication; in this case, the first computer or computer network must check whether the selected user has the authenticated identity on its list of accounts before allowing the selection to be completed.

Following selection of a particular user to access resources from, the data requester is then permitted to choose a desired resource associated with that selected user. Each user of the first computer or computer network creates an access control list for each resource it is permitted to provide others with access to. The access control list contains the identity of data requesters who are allowed access to that particular resource and a level of data access to provide to them. Data requesters are only able to see a list of available resources that the selected user has designated as accessible by the data requester. The available resources may comprise computer data or computer applications and may be stored on a particular computer on the first computer network or at any other network accessible location. The selection of users and resources may be accomplished manually or automatically by a piece of software designed to work in conjunction with the method of the present invention.

If a single user group is configured that comprises substantially all of the users of the first computer or computer network, then all data requesters having permission to access resources on the first computer or computer network are present on that group's list of accounts. Once authenticated, the data requester can access any resource that has the requester's identity on its access control list. This is particularly useful, for example, when the method is employed internally in a corporate setting to provide a pre-determined level of access for each employee to shared network resources while otherwise preventing the employees from designating outsiders that may have access.

In one embodiment, a user may comprise a personal id or a machine id present on the first computer or computer network. A machine id may be able to provide automated access to certain resources (for example, provide a user with remote access to his or her personal data stored on that machine), whereas a personal id may be able to provide access to certain personally sensitive resources (for example, the ability to send email originating from the personal id). A personal id normally requires a data requester to provide a password or passphrase to enable access, providing an additional layer of security to prevent unauthorized use of personal data.

Once a user or group of users and a resource associated with that user or group of users are selected, the first computer or computer network sends an encrypted response to the second computer or computer network. The encrypted response is asymmetrically encrypted using a private key of the first computer or computer network, preferably the private key of the selected user, and is decrypted using the data requester's copy of the corresponding public key. The encrypted response typically contains a hash of the symmetric encryption key concatenated with the second data string. By decrypting the response using the public key and obtaining the same numeric value for the hash, the second computer verifies that it is communicating with the selected user and that there is no “man in the middle”.

After this verification is complete, the data requester is provided with the level of secure access to the resource as specified by the user in its access control list for that resource. The level of secure access to a particular shared resource on the first computer or computer network is therefore a function of the identity of the data requester and of the user that has been selected to access the resource through. The pre-determined level of secure access is normally provided over the secure connection using the pre-established symmetric encryption tunnel; however, other more secure methods may be used depending upon the sensitivity of the resource being accessed.

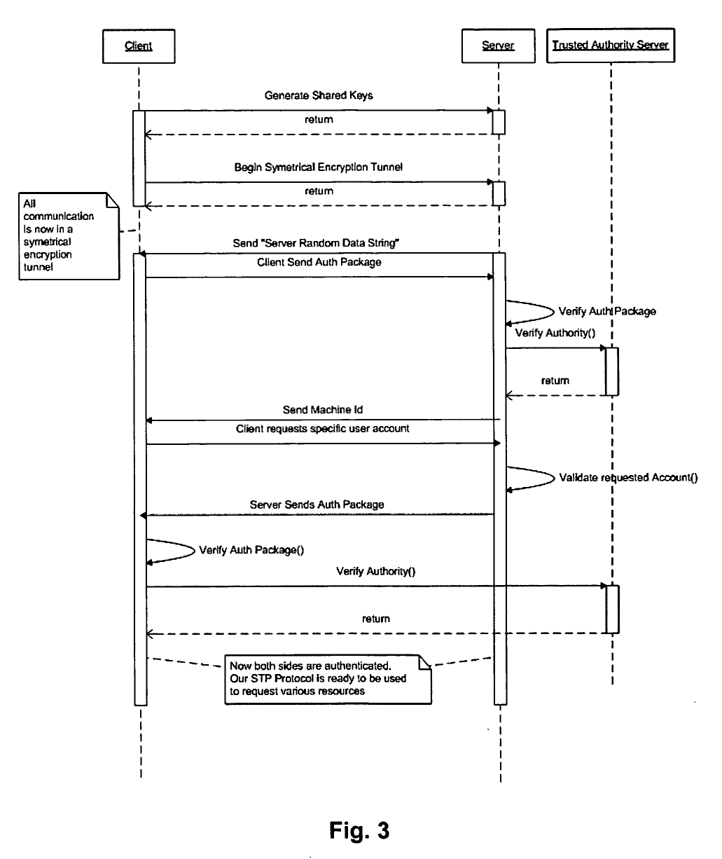

In a related aspect of the invention, a level of trust is ascribed to the authenticated identity by consulting a trust table. The trust table provides an indication of the degree of trust to place upon the authenticity of a particular identity. For example, an identity that is known to have been compromised by a hacker could be ascribed a low trust level, whereas employees of a company who are known to have valid identities on the first network could be ascribed a higher level of trust. The trust level is then used as an additional factor in determining the level of secure access to be provided to a data requester or group of data requesters. Trust tables are accessible from one or more trust authorities and a schematic representation of the invention incorporating trust tables is illustrated in FIG. 3.

The trust table comprises an identity of a data requester and a trust level in at least one trust category. Any number of categories may be provided for the trust table. Each identity has a trust level in each category, typically a numerical value from 1 to 100. The numerical value is assigned by the trust authority maintaining the trust table and is usually determined automatically according to an algorithm that takes into account the experiences of a plurality of users in a particular trust category. The overall effect of the trust level is to ascribe a level of confidence to the veracity of the identity of the data requester.

Trust authorities are either users of the first computer or computer network or users on a third-party trust server that can be accessed using a secure connection. If trust information on a particular identity is not available from a designated primary trust authority, that authority normally designates a secondary trust authority, typically on a third-party trust server, to provide the trust information. In this way, a chain of trusted authorities is created so that a trust level can be determined irregardless of whether a particular identity is known to the primary trust authority. This allows members of the public to have access to certain system resources, even though they are not known personally to a user designated as a primary trust authority of the first computer or computer network. For example, a person seeking access to personal tax data from a government server could obtain that data based on the trust authority verifying that person's identity, without having to login to the government server, provide a password, or provide other personal identifying information.

A third-party trust authority can provide public certificate information in conjunction with trust and routing information, in much the same was as a phone book provides identity information in conjunction with phone number and address information. The trust authority can also provide an encrypted storage of private key information to allow those private keys to be restored should they become lost or damaged, obviating the need for revoking the certificate by attributing a low trust level to the identity. When a certificate is voluntarily retired, the certificate can be archived to a vault associated with the third-party trust authority. The vault is used to permit a certificate to be removed from active circulation, but permits an updated certificate to be provided to a primary trust authority when it connects to the third-party trust authority upon seeking to ascribe a trust level. In this manner, updated information is disseminated without intervention by the data requester and apparent continuity is provided for the data requester without being shut out of certain systems due to a low trust level.

Trust authorities are normally used in conjunction with user discriminated access to system resources. However, in another embodiment, a trust authority can be setup at large and used to verify the veracity of the identities of individuals using certain certificates. These trust authorities function as previously described and can be used to provide certificate expiration information. For example, if the identity represented by a particular certificate is user@corporation.com and User no longer works for Corporation, then Corporation can notify the third-party trust authority that the certificate is invalid. Trust authorities can be used in this manner with many existing secure access protocols that depend upon certificates, such as SSH, VPN, SSL, Kerberos™, WEP, Bluetooth™, and Windows™ Login.

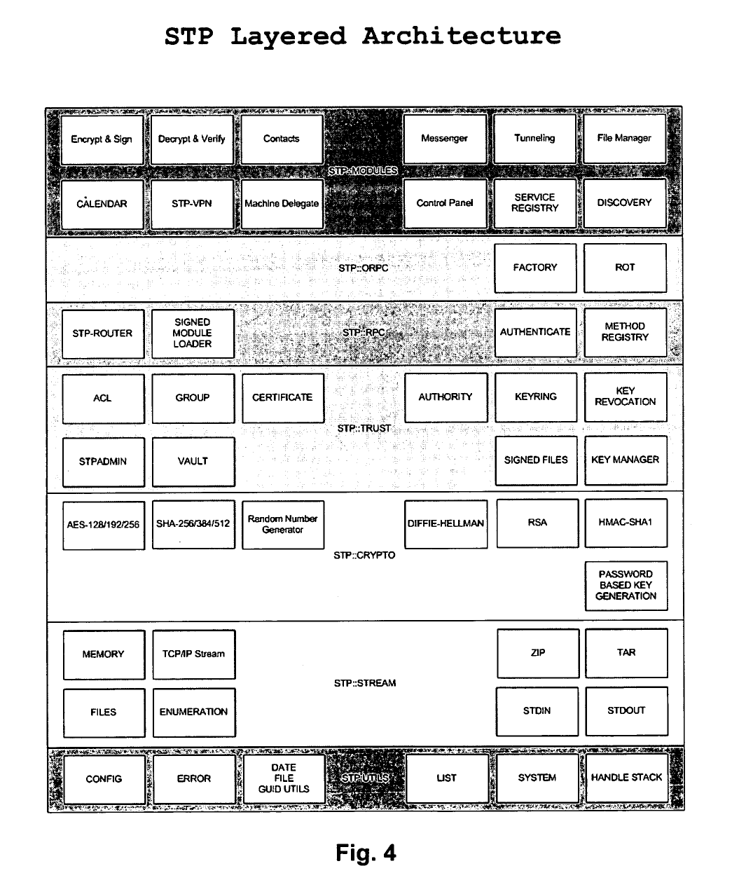

The present invention is executed through a plurality of application modules. FIG. 4 shows a layered architecture of modules according to the present invention. Each stage of the method is represented by a different layer and each layer has a plurality of modules. The modules execute the steps of the method previously described and other steps known to persons skilled in the art that are used to facilitate communication and data exchange between the first and second computer networks; for example, in the lower levels of the architecture the TCP/IP module, FILES module and MEMORY module are used to establish and facilitate basic communications and pass basic data back and forth. The middle levels of the architecture relate to the initial stages of the method; for example, the CRYPTO level contains the Random Number Generator module that is used to generate the first and second data strings and the DIFFIE-HELLMAN module that is used to generate the symmetric encryption key. The TRUST level of the architecture contains the AUTHORITY module, used to access a table of authorities, the CERTIFICATE module, used to authenticate certificates and the ACL module, used to provide the Access Control List for a particular desired resource related to a selected user. The highest levels of the architecture contain modules used to complete secure data transfer functions and to provide secure application access. For example, the highest level contains the CALENDAR, FILE MANAGER and CONTACTS modules that are used to pass user specific data over the secure connection.

At the highest level, or MODULE level, the method makes extensive use of three core modules. The SERVICE REGISTRY module records the identity of all modules installed on the system, along with their certificates and provides other modules in the system with the information required to authenticate and load any particular module. The DISCOVERY module provides information to the data requester about which modules are available as resources for the particular user they are connecting through. The data requester is able to select a desired resource by selecting one of the available modules. The MACHINE DELEGATE module provides access to resources on the first computer or computer network when the user that access is being requested through is not logged in. The ACL relating to that user for resources sought to be accessed by a data requester is respected by the MACHINE DELEGATE module so that the pre-determined level of access to a particular desired resource is still provided to the data requester. However, the MACHINE DELEGATE module typically has a lesser set of access permission levels available to it than if a user were actually logged in. This prevents the MACHINE DELEGATE module from executing functions that provide access to resources that would normally require a user to be present (for example, the sending of email).

Each of the highest level modules communicates using an exposed Application Programming Interface (API) that allows anyone to create modules that function in accordance with the method. This API provides for a number of features that are common to each module. For example, each module is able to save and restore its configuration state, its own internal access control list (exclusive for the module's use), and to access modules in certain other layers of the architecture in order to complete desired functions (eg: to communicate, pass data between computers, etc.)

Each module is digitally signed and that signature is verified using a trust authority in the manner previously described for individual users and data requesters. The modules are signed to prove the authenticity of the module to the data requester and to ensure that a hacker or other unscrupulous individual has not provided a virus or other harmful application on a first computer network that an unsuspecting data requester seeks access to. Known hackers who sign modules would have a low trust level on third-party trust authorities and the data requester could choose not to execute a module signed by someone having a trust level below a certain threshold. Module authentication is completed at the RPC level of the layered architecture. Similarly, a module that seeks to upload information to the first computer or computer network would have to have a trust level above a certain value and have an access level that permits the uploading of data in order to complete the upload.

### EXAMPLE

The following provides an example of an embodiment of the present invention using pseudo-code and is directed to a person skilled in the art. The pseudo-code in the left hand column represents modules and procedures that are executed on the second computer or computer network, whereas the pseudo-code in the right hand column represents modules and procedures that are executed on the first computer or computer network. Lines of pseudo-code are executed sequentially so that code appearing in both columns on the same line is executed in parallel.

| Second computer or computer network | First computer or computer network |
|---|---|
| //Connect | //Wait for connection |
| MyId = GetMyIdentity( ); | |
| MyCert = GetLocalCert( MyId ); | |
| CertHash = GetMyIdentityHash( MyCert ); | |
| YourId = “jim@example.com”; | |
| YourCert = GetCert(YourId); | |
| ConnectToId( MyCert, YourId ); | |
| | AcceptConnection( ); |
| //Generate Symetrical Key | //Generate Symetrical Key |
| InitiateKeyExchange( ); | |
| | sek = AddressKeyExchange( ); |
| Sek = CompleteKeyExchange( ); | |
| //All communication is now | //All communication is now |
| //in a symmetrical encryption | //in a symmetrical encryption |
| //tunnel | //tunnel |
| //Now we must authorize | //Now we must authorize |
| //and authenticate identities | //and authenticate identities |
| | ServerRndString = RandomDataString( ); |
| | Write( ServerRndString ); |
| ServerRndString = Read( ); | |
| ClientRndString = RandomDataString( ); | |
| Write( MyId ); | |
| Write( CertHash ); | |
| //WritePrivate encrypts data using a | |
| //private key. | |
| WritePrivate(MyCert, Hash(Sek + | |
| ServerRndString)); | |
| WritePrivate (MyCert, ClientRndString ); | |
| | ClientId = Read ( ); |
| | ClientIdHash = Read ( ); |
| | ClientCert = GetCertFromIdAndHash(ClientId, |
| | ClientIdHash); |
| | if (!ClientCert) |
| | { |
| | Write(Failure); |
| | return; //exit connection attempt |
| | } |
| | //ReadPublic decrypts data using a |
| | //public key. |
| | ClientKeyHash = ReadPublic(ClientCert); |
| | ClientRndString = ReadPublic(ClientCert); |
| | //Confirm Client is using the same |
| | //symmetrical encryption key as we are |
| | keyok = ChkKey(sek, ServerRndString, |
| | ClientKeyHash); |
| | if (!keyok \|\| !ClientRndString) |
| | { |
| | Write(failure); |
| | return; //exit connection attempt |
| | } |
| | Write( success ); |
| | Write( MyMachineIdentity ); |
| result = Read( ); | |
| if (!result) | |
| return; //exit connection attempt | |
| YourMachinesId = Read( ); | |
| //Tell first comp. who you wish to connect to | |
| Write(YourId); | |
| | LocalId = Read( ); |
| | LocalCert = GetLocalCert(LocalId); |
| | TrustOk = CheckTrustTables(LocalCert, |
| | ClientCert); |
| | if (!TrustOK) |
| | { |
| | Write(failure); |
| | return; //exit connection attempt |
| | } |
| | AclOk = CheckAcl(LocalCert, ClientCert, |
| | NET_ACCESS); |
| | if (!AclOK) |
| | { |
| | Write(failure); |
| | return; //exit connection attempt |
| | } |
| | Write( success ); |
| | //WritePrivate encrypts data using a |
| | //private key. |
| | WritePrivate(LocalCert, Hash (Sek + |
| | ClientRndString)); |
| result = Read( ); | |
| if (!result) | |
| return; //exit connection attempt | |
| //ReadPublic decrypts data using a | |
| //public key. | |
| ServerKeyHash = ReadPublic(ServerCert); | |
| //Confirm first comp. is using the same | |
| //symmetrical encryption key as we are | |
| keyok = ChkKey(sek, ClientRndString, | |
| ServerKeyHash); | |
| if (!keyok) | |
| { | |
| Write(failure); | |
| return; //exit connection attempt | |
| } | |
| Write(success); | |
| | result = Read( ); |
| | if (!result) |
| | return; //exit connection attempt |
| //the symmetrical encryption tunnel | //the symmetrical encryption tunnel |
| //is now authenticated and authorized | //is now authenticated and authorized |
| //This is now known as an STP-RPC Tunnel | //This is now known as an STP-RPC Tunnel |
| //We now provide an example of the client | |
| //initiating a request to chat to the | |
| //remote user using the STP Messenger Module | |
| //WriteProcedure( ) checks My Access Control | |
| //Lists to ensure that I allow the remote | |
| //user to access this module on my machine | |
| //wargc and wargv represent one way to bundle | |
| //the procedure parameters. | |
| Que = CreateQuestion(STP_Messenger, wargc, | |
| wargv); | |
| WriteProcedure (Que); | |
| | Que = ReadProcedure( ); |
| | //LoadMod internally calls |
| | //CheckAcl(LocalCert, ClientCert, Que.MODULE) |
| | //Next, it checks the module is signed, |
| | //trusted, and authorized to run on this |
| | //machine. It then loads the module into |
| | //memory |
| | Module = LoadMod(LocalCert, ClientCert, |
| | Que.MODULE); |
| | if (Module) |
| | Write(failure); |
| | //Module.ExecProcedure( ) processes the |
| | //Question and may present the question to |
| | //the user on this machine in the form of a |
| | //Chat User Interface |
| | Ans = Module.ExecProcedure (Que.wargc, |
| | Que.wargv); |
| | AnswerProcedure(Que, Ans); |
| Ans = ReadAnswer(Que); | |
| | //We now provide an example of the server |
| | //initiating a request to chat to the |
| | //remote user using the STP Messenger Module |
| | //WriteProcedure( ) checks My Access Control |
| | //Lists to ensure that I allow the remote |
| | //user to access this module on my machine |
| | //wargc and wargv represent one way to bundle |
| | //the procedure parameters. |
| | Que = CreateQuestion(STP_Messenger, wargc, |
| | wargv); |
| | WriteProcedure(Que); |
| Que = ReadProcedure( ); | |
| //LoadMod internally calls | |
| //CheckAcl(LocalCert, ClientCert, Que.MODULE) | |
| //Next, it checks the module is signed, | |
| //trusted, and authorized to run on this | |
| //machine. It then loads the module into | |
| //memory | |
| Module = LoadMod(LocalCert, ClientCert, | |
| Que.MODULE); | |
| if (Module) | |
| Write(failure); | |
| //Module.ExecProcedure( ) processes the | |
| //Question and may present the question to | |
| //the user on this machine in the form of a | |
| //Chat User Interface | |
| Ans = Module.ExecProcedure(Que. wargc, | |
| Que.wargv); | |
| AnswerProcedure(Que, Ans); | |
| | Ans = ReadAnswer(Que); |

Other advantages which are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A method of providing varying levels of secure access to computer resources on a first computer or computer network having at least one user or group of users, the method comprising:
a) establishing a secure connection between a second computer or computer network and the first computer or computer network using a common symmetric encryption key, the second computer or computer network having at least one data requester or group of data requesters;
b) providing an identity and an authentication package of the requester or group of requesters to the first computer or computer network over the secure connection, the authentication package encrypted using a private key of the requester or group of requesters;
c) for each user or group of users, checking the identity against a list of accounts associated with that user or group of users and determining whether at least one list of accounts contains the identity;
d) authenticating the identity by decrypting the authentication package using a public key associated with the identity;
e) for an authenticated identity, selecting a particular user or group of users it desires to access resources from over the secure connection;
f) for a selected user or group of users, checking whether the authenticated identity is on its list of accounts;
g) for a desired resource associated with the selected user or group of users, checking an access control list to determine the level of secure access to be provided to the requester or group of requesters for that resource, the level of secure access determined based upon both the selected user or group of users and the authenticated identity; and,
h) providing the pre-determined level of secure access to the resource over the secure connection.

2. The method according to claim 1, wherein, after determining the level of secure access to be provided to the requester or group of requesters, the method further comprises sending an encrypted response from the first computer or computer network over the secure connection, the response encrypted using a private key associated with the first computer or computer network.

3. The method according to claim 2, wherein the encrypted response is decrypted by the second computer or computer network using a public key corresponding to the private key used to encrypt the response.

4. The method according to claim 2, wherein the response is encrypted using a private key of the selected user or group of users.

5. The method according to claim 4, wherein the encrypted response is decrypted by the second computer or computer network using a public key of the selected user or group of users.

6. The method according to claim 2, wherein step a) further comprises transmitting a first data string from the first computer or computer network to the second computer or computer network via the secure connection.

7. The method according to claim 6, wherein the authentication package comprises a second data string and a hash of a combination of the symmetric encryption key and the first data string.

8. The method according to claim 7, wherein the encrypted response comprises a hash of a combination of the symmetric encryption key and the second data string.

9. The method according to claim 7, wherein the first and second data strings are randomly generated.

10. The method according to claim 1, wherein the symmetric encryption key is generated by both the first computer or computer network and the second computer or computer network using a Diffie-Hellman key exchange algorithm.

11. The method according to claim 1, wherein, in step b), a hash of a certificate corresponding to the identity of the data requester or group of data requesters is provided to the first computer or computer network over the secure connection.

12. The method according to claim 1, wherein a listing of available resources associated with the selected user or group of users is only accessible by the requester or group of requesters following step f).

13. The method according to claim 1, wherein the desired resource comprises data specific to the user or group of users.

14. The method according to claim 1, wherein the desired resource comprises an executable module.

15. A method of providing varying levels of secure access to computer resources on a first computer or computer network, the method comprising:
a) establishing a secure connection between a second computer or computer network and the first computer or computer network using a common symmetric encryption key, the second computer or computer network having at least one data requester or group of data requesters;
b) providing an identity and an authentication package of the requester or group of requesters to the first computer or computer network over the secure connection, the authentication package encrypted using a private key of the requester or group of requesters;
c) checking the identity against a list of accounts on the first computer or computer network and determining whether the list of accounts contains the identity;
d) authenticating the identity by decrypting the authentication package using a public key associated with the identity;
e) ascribing a level of trust to an authenticated identity based upon one or more trust tables;
f) checking an access control list for the resource to determine the level of secure access to be provided to the requester or group of requesters, the level of secure access depending upon both the authenticated identity and the level of trust; and,
g) providing the pre-determined level of secure access to the resource over the secure connection.

16. The method according to claim 15, wherein the method further comprises updating the level of trust on at least one trust table.

17. The method according to claim 15, wherein at least one trust table is located on a third computer or computer network.

18. The method according to claim 17, wherein the trust table on the third computer network is accessed over a second secure connection.

19. The method according to claim 15, wherein the trust table comprises trust information provided by a plurality of users or groups of users.

20. A method of providing varying levels of secure access to computer resources on a first computer or computer network having at least one user or group of users, the method comprising:
a) establishing a secure connection between a second computer or computer network and the first computer or computer network using a common symmetric encryption key, the second computer or computer network having at least one data requester or group of data requesters;
b) providing an identity and an authentication package of the requester or group of requesters to the first computer or computer network over the secure connection, the authentication package encrypted using a private key of the requester or group of requesters;
c) for each user or group of users, checking the identity against a list of accounts associated with that user or group of users and determining whether at least one list of accounts contains the identity;
d) authenticating the identity by decrypting the authentication package using a public key associated with the identity;
e) ascribing a level of trust to an authenticated identity based upon one or more trust tables;
f) for the authenticated identity, selecting a particular user or group of users it desires to access resources from over the secure connection;
g) for a selected user or group of users, checking whether the authenticated identity is on its list of accounts;
h) for a desired resource associated with the selected user or group of users, checking an access control list to determine the level of secure access to be provided to the requester or group of requesters for that resource, the level of secure access determined based upon the selected user or group of users, the authenticated identity and the level of trust; and,
i) providing the pre-determined level of secure access to the resource over the secure connection.
